(19) United States
(12) Patent Application Publication
(10) Pub. No.: US 2024/0194197 A1
(43) Pub. Date: Jun. 13, 2024

(54) SYSTEMS, DEVICES AND METHODS FOR AFFECTIVE COMPUTING

(71) Applicant: EMOTIONAL CLOUD, INC., Lewes, DE (US)

(72) Inventors: Roger LOVE; Scott ALBERTS; Cindy GORDON, Toronto (CA)

(21) Appl. No.: 18/287,805

(22) PCT Filed: Apr. 20, 2022
(86) PCT No.: PCT/US2022/025606

§ 371 Date: Oct. 20, 2023

Related U.S. Application Data
(60) Provisional application No. 63/178,254, filed on Apr. 22, 2021.

(51) Int. Cl. G10L 15/22; G06F 3/01; G10L 15/02; G10L 15/16; G10L 25/63

(52) U.S. Cl. CPC G10L 15/22; G06F 3/011; G10L 15/16; G10L 25/63; G06F 2203/011; G10L 2015/027; G10L 2015/223

(57) ABSTRACT

The present specification provides systems, devices, and methods for affective categorization of captured messages, comprising receiving captured voice messages from a device, isolating the syllable segments of the voice messages, extracting a set of paralanguage attributes from the segments, then determining an affective categorization associated with the voice message. The affective categorization of the voice message is sent back to the device. The device is then controlled to respond to the voice message based on the received affective categorization. Paralanguage attributes can be comprised of five categories: pitch, pace, tone, melody, and volume.

### PRIORITY

The present specification claims priority from US Provisional Patent Application U.S. 63/178,254 filed Apr. 22, 2021, the contents of which are incorporated herein by reference.

### FIELD

The present specification relates generally to computing and more generally relates to systems, devices and methods for affective computing.

More particularly, the invention concerns a method for detecting and classifying emotion from voice samples of speech and sounds and providing a relevant emotional voice response delivered by a machine or a human. Further, the invention concerns a computer system and method for detecting and classifying emotion in human speech and generating an appropriate emotional response via machine or human output, using a unique set of emotional classifications.

### BACKGROUND

Affective computing is the detection, interpretation, and processing of emotion from sound input signals by a computer. In human speech, this is an important component of natural language comprehension in human machine communications.

For example, the ability of a collaborative robot or “cobot” (first introduced in U.S. Pat. No. 5,952,796), to offer the appropriate responses to human speech is enhanced by the accurate detection of an emotional state. In a more detailed example, a cobot may detect and classify a human's speech as sad and then produce a response demonstrating empathy by employing a lower pitch spoken response to soothe and connect more deeply with the human. However, humans move from one emotion to the next, and therefore the cobot would need to recognize each specific emotion, and precisely when the human transitioned from one emotion to another in order to appropriately respond accordingly to multiple sentences in a conversation.

### SUMMARY

Described herein and in accompanying documents are methods, systems, and devices for affective computing, and specifically for detecting and classifying emotion in human speech.

In accordance with an aspect of the invention, there is provided a method for affective computing comprising receiving, at a processor, a captured voice message from an input device. At the processor, syllable segments of the voice message are then isolated, and paralanguage attributes of the voice message are extracted. Additionally, at the processor, an affective categorization associated with the voice message is determined, and the determined affective categorization is sent to an output device. The output device is then controlled to respond to the voice message based on the affective categorization. The processor can be located within a server. The input device and the output device can be located within a computing device. The computing device can be, by way of non-limiting examples, a virtual reality (VR) headset, a smart refrigerator, a vending machine, or a call center workstation. As an illustration of the many applications of the present invention, according to the vending machine example, the vending machine can hold a plurality of types of dispensable articles, and a different type of article can be dispensed via the output device based on the determined affective categorization.

The paralanguage attributes can comprise one or more of pitch, pace, tone, melody, and volume. The paralanguage attributes can comprise of all five of pitch, pace, tone, melody, and volume. The paralanguage attributes can have an associated weighting coefficient. The weighting coefficient can be determined through an artificial intelligence training exercise, comprised of receiving a plurality of voice samples and associated emotional interpretations. The weighting coefficient can be increased or decreased during each iteration during the artificial intelligence training exercise. The artificial intelligence training exercise can be performed by, for example, human trainers working with an initial training set, an AI “trainer” which itself is configured to perform the role of the human trainer, or by an actual user that corrects a computationally determined affective categorization with a correct emotional interpretation, such that actual use of the systems, apparatuses and methods herein results in an ongoing artificial training exercise.

In accordance with an aspect of the invention, there is provided an apparatus for affective computing comprising an interface for receiving a voice message including a plurality of syllable segments. A processor is connected to the interface and isolates the syllable segments as well as extracts a set of paralanguage attributes from the voice message. The processor is configured to determine an affective categorization of the voice message and send a control signal including the affective categorization through the interface. The apparatus can be a server and the interface can be connected to a computing device that comprises a microphone for capturing a voice message and an output device for responding to the control signal. The apparatus can be a computing device and the interface can include a microphone that captures voice messages and an output device that responds to the control signal. The computing device can be a VR headset, a smart refrigerator, a vending machine, or a call center workstation. The vending machine can comprise a plurality of types of dispensable articles, and one of said types is dispensed through the output device based on the determined affective categorization.

In accordance with an aspect of the invention, there is provided a system for affective computing comprising at least one input device that is connectable to a network, and at least one output device respective to at least one input device. The system further comprises a processor connectable to the network that is configured to receive a voice message from at least one input device and isolate the syllable segments of the voice message. The processor will then extract a set of paralanguage attributes of the voice message and determine an affective categorization associated with the voice message. The affective categorization is then sent from the processor to one of the output devices, and the output device is controlled to respond to the voice message based on the affective categorization. The processor, the input device, and the output device can be located within a computing device. The processor can be located within a server that is remote from a computing device that comprises at least one input device and at least one output device. The paralanguage attributes can comprise one or more of pitch, pace, tone, melody, and volume. The paralanguage attributes can also comprise all five of pitch, pace, tone, melody, and volume.

In accordance with another aspect of the invention, there is provided a computer system for detecting and classifying emotion in human speech, including an emotional connector application programming interface (API) that receives input speech samples to deliver output speech samples. The system further includes an emotion detector to classify the emotion type derived from the speech samples. Further, an emotional mapper provides the analytical validation on the accuracy of the emotion with a confidence layer. An emotion responder will generate the emotional response output speech samples.

In accordance with another aspect of the invention, there is provided a method for detecting and classifying emotion in human speech, including acquiring audio speech samples via the API layer and isolating the samples into syllable segments. The attributes for each segment are then extracted, the attributes comprising pitch, pace, tone, volume, and melody. The segments are then classified into primary and secondary emotions based on the attributes and an emotional vocal score is determined to identify the most strongly registered emotions. The accuracy of the emotion is then validated through a confidence layer. The appropriate emotion sequence is then activated, and an appropriate emotional response to the voice sample is then generated.

Various advantages and features consistent with the present specification will become apparent from the following description with reference to the drawings.

### BRIEF DESCRIPTION OF THE DRAWINGS

Reference to certain embodiments of the invention, by way of example only, will now be described in relation to the attached Figures in which:

FIG. 1 is a generally schematic view illustrating the components of the system used in the preferred embodiment the system of the present invention.

FIG. 2 is a generally diagrammatic view illustrating the various steps of one form of the method of the invention.

FIG. 3 is a generally diagrammatic view of an example of detecting happiness versus anger in the speech method and system the invention for detecting, classifying, and responding to emotion derived from human speech.

FIG. 4 is a block diagram representing a system for affective computing.

FIG. 5 is a block diagram representing a server apparatus for affective computing.

FIG. 6 is a block diagram representing an input device apparatus for affective computing.

FIG. 7 is a flow chart representing a training method to train a processor and artificial intelligence to detect and classify affective categories of voice samples.

FIG. 8 is a flow chart representing a method of extracting five components of paralanguage attributes from an voice sample.

FIG. 9 is a table showing examples of the values assigned to each emotion.

FIG. 10 is a flow chart representing a method for a processor to detect and classify affective categories of voice messages.

FIG. 11 is a flow chart representing a method for an input device to send a voice message to a server and receive the affective categorization of the voice message.

### DETAILED DESCRIPTION

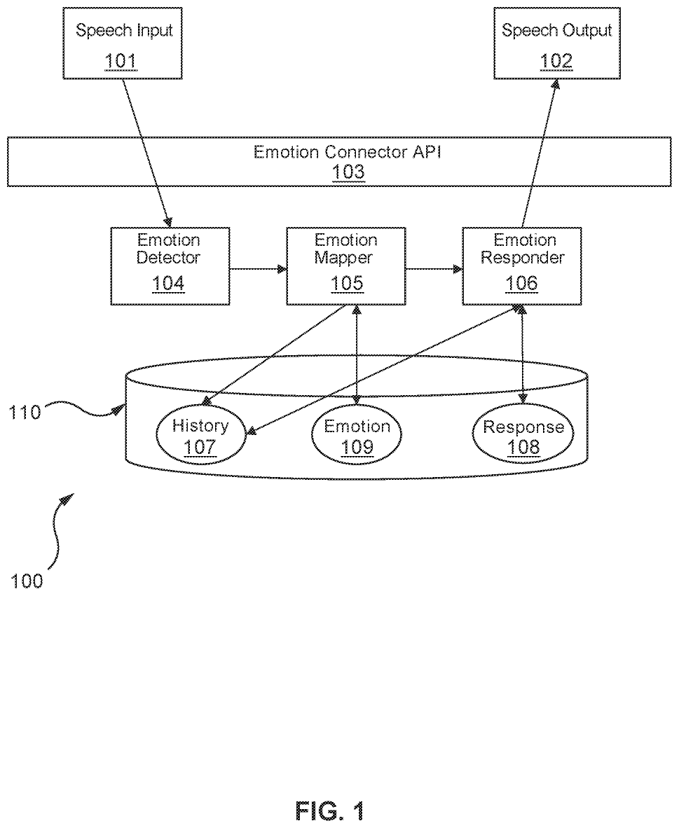

Referring to the drawings and particularly to FIG. 1, an embodiment of this invention comprises a system 100 of one or more interconnected computational modules including:
Speech Input module 101 to record or acquire audio speech samples;
Emotion Connector Application Programming Interface (“API”) 103 to receive input speech samples and to deliver output speech samples;
Emotion Detector 104 that accepts voice samples of speech input from Speech Input module 101 via Emotion Connector API 103 and determines the emotion expressed in the samples;
History Log 107 that keeps track of the current and all previous input emotions and responses;
Emotion Classifiers 109 including predetermined weighting coefficients for primary and secondary emotions;
Emotion Mapper 105 that receives the voice sample emotion expression and determines appropriate emotional classifications for the samples based on the Emotion Classifiers 109;
Response Library 108 comprising previously derived and stored conversation graphs including optimal responses to speech (dialog);
Emotion Responder 106 that transforms the information response, history responses and emotional response into output speech samples selected from the content of the Response Library 108 of optimal responses;
Speech Output module 102 that delivers output speech samples via the Emotion Connector API 103.

The Emotion Responder 106 uses pre-coded Response Library 108 and includes a responder engine that maps emotion inputs to emotional responses relevant to coaching the response receivers towards different emotional states advantageous to effective conversation engagement. Emotion changes in communication, for example, from very angry to calm emotion, have an emotion sequence that is a progression of shifting parameters in the five components of paralanguage attributes that may be used as a guide and as feedback to the responder engine.

In the example of a call center workstation, the Emotion Responder 106 may receive a classification from the Emotion Classifiers 109 that the sounds that were input may be ‘angry’. In the response to this, the Emotion Responder 106 may coach by providing one or more actionable instructions to the Speech Output module 102 such as to lower the pitch, going to a lower note, as well as the pace, by speaking slower, and decreasing the volume, and thereby demonstrating a calm and empathetic emotional sound response.

The Emotion Responder 106 may include a library of emotional personas and use prescriptive Artificial Intelligence (AI) analytics models to determine the optimal emotional sound and pre-scripted speech response enhanced with context and outcome classifiers.

Speech Output module 102 may be delivered by a machine or a human in executing the one or more actionable instructions.

In an embodiment, Emotion Responder 106 may access a library of different responses provided by Response Library 108. Method and System for Detecting, Classifying and Responding to Emotion derived from Human Speech.

In an alternative embodiment, Emotion Responder 106 may integrate via Emotion Connector API 103 with pre-scripted dialogue libraries from third parties to train the AI models. In a further example, an AI chatbot delivery system may provide a third-party library of pre-scripted dialogues.

It should be evident that Emotion Connector API 103 may be adapted to support third party data methods and interfaces.

Response Library 108 may, over time, be enhanced using extensive and continuous feedback from the History Log 107 to improve the emotional response capabilities. AI Techniques used to improve responses may include deep learning, graph theory, predictive analytics, prescriptive analytics, and natural language processing (NLP) methods to determine sentiment, context, outcome classifications.

System 100 may comprise one or more computing units including CPU, memory, persistent data storage, network input/outputs and computer-readable media containing program instructions.

In an embodiment, the system may be embodied as Internet-connected cloud computing components and may be accessible as the Emotional Cloud via Emotion Connector API 103.

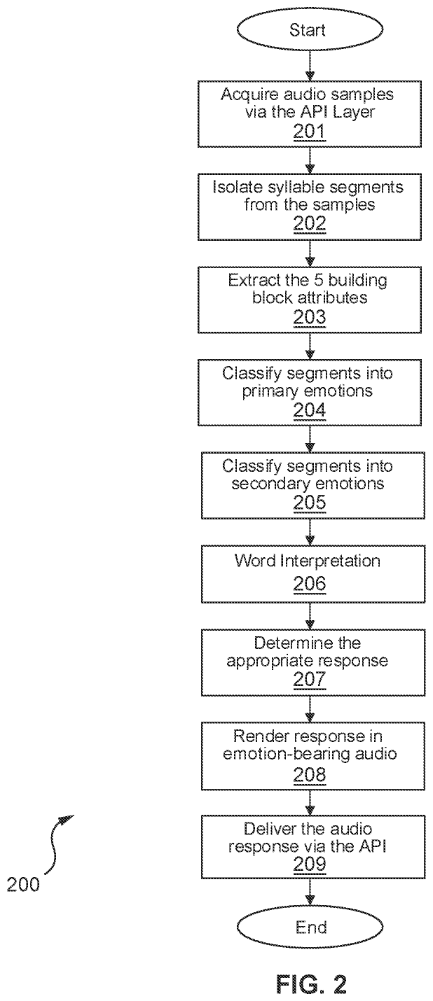

The method used in an embodiment, with reference to the steps 200 in FIG. 2, includes:
Acquiring audio speech samples via the API layer 201;
Isolating the samples into syllable segments 202;
Extracting the five components of paralanguage attributes 203 for each segment: pitch, pace, tone, volume, melody wherein:
Pitch is measured by the frequency on the musical scale that the voice dominantly centers around;
Pace is measured by 2 variables: the beats per minute (“BPM”) speed of the vocal sounds attached to the words as they move from syllable to syllable and the length of silence in between the words and sentences;
Tone is measured by combinations of tonal frequency durations based on the sounds of less air or more air;
Volume is measured by the intensity of the sound wave;
Melody is measured by the sequence of musical notes that the voice creates as it moves from one note to the same note, one note to a higher note, or one note to a lower one.
Classifying the segments into primary emotions 204 (such as, but not limited to: fear, disgust, anger, surprise, happiness, sadness) by assigning one or more numerical values to each of the five components of paralanguage attributes and then combining them using a set of predetermined weighting coefficients for each of the primary emotions into an emotional vocal score to determine the most strongly registered emotion, classifying, similarly, the segments into secondary emotions 205 (such as, but not limited to: embarrassment, excitement, contempt, shame, pride, satisfaction, amusement);
Determining the word information associated with the audio speech samples 206 using well known speech-to-text methods;
Activating the appropriate emotion sequence 207 to generate an information response and an appropriate emotional response to the voice samples based on previously derived and stored conversation graphs;
Transforming 208 the information response and emotional response into an emotional audio speech response;
Delivering 209 the audio response via the API.

From the method as described herein, it is evident that the classifying of emotion taught herein is not dependent on the word information and is also independent of the gender, accent, and regional influences in the speech samples.

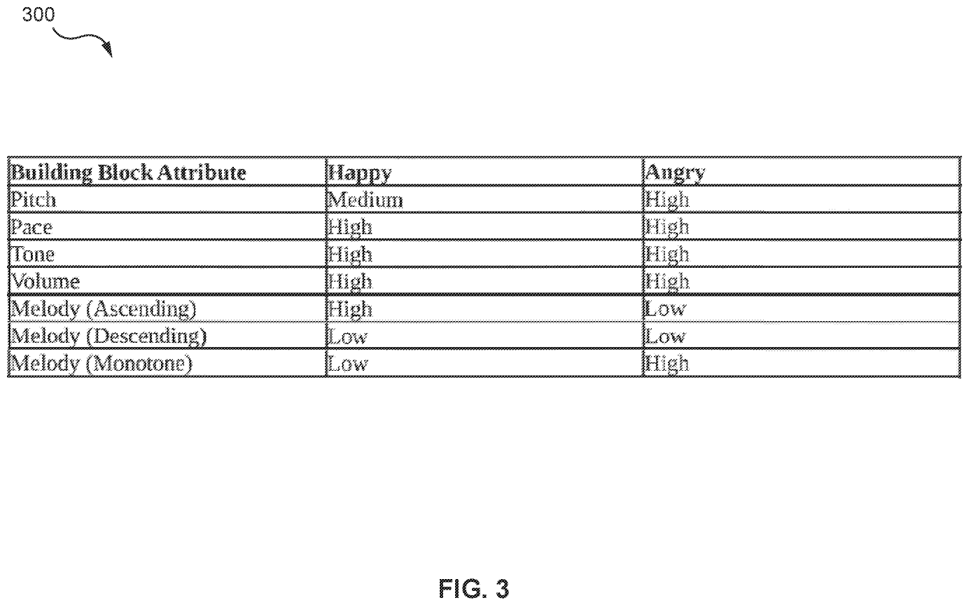

FIG. 3 shows an illustrative example of how happiness and anger may be differentiated within the voice segments. In mathematical terms, this may be modelled by a support vector machine (SVM) for each of the emotions using:
B_{c}=K_{Pi}Aₚᵢ+K_{Pa}A_{Pa}+K_{T0}A_{T0}+K_{V0}A_{V0}+K_{Mel. Asc}A_{Mel.Asc}+K_{Mel,Desc}A_{Mel,Desc}+K_{Mel.Mon}A_{Mel.Mon}, where Be is the emotion and K_{Pi}, K_{Pa}, K_{T0}. K_{V0}. K_{Mel.Asc}. K_{Mel,Desc}. K_{Mel.Mon} are the model weighting coefficient sets derived from the training system model using pre-recorded voice clips.

From the evaluation of the emotion values Be, a confidence value may be assigned to each of the emotions. In the example of FIG. 3, emotion ‘Happy’ may be chosen if the value of the ascending melody feature is greater than the monotonous melody feature, and emotion ‘Angry’ may be chosen otherwise. Similarly, a multiclass SVM model may be trained to decide between any number of different emotions. The computation may also include a numerical confidence index/scale for more accurate pattern detection.

In another aspect of this invention, other forms of emotional classifiers of input may be used to determine emotion, such as, but not limited to, facial expressions, hand gestures, gait, and posture.

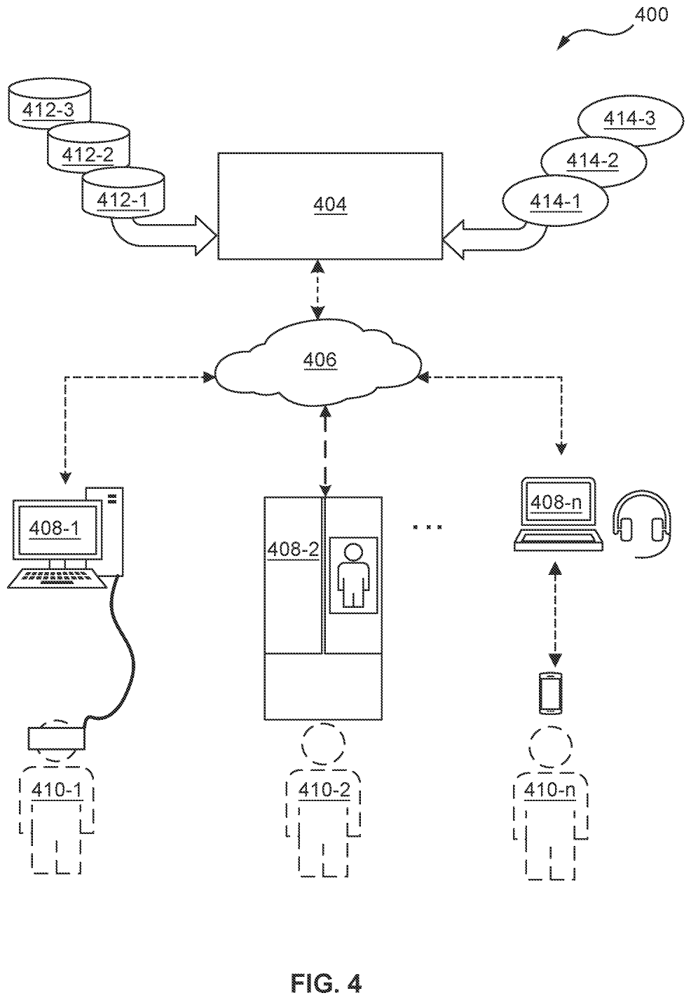

Referring now to FIG. 4, according to another embodiment, a system for affective computing is indicated generally at 400. The locus of the system 400 is a central server 404 that is connectable to a network 406, such as the Internet. System 400 also includes at least one computing device 408-1, 408-2 . . . 408-n (Collectively, the computing devices 408-1, 408-2 . . . 408-n will be referred to as computing devices 408, and generically, as computing device 408. This nomenclature is used elsewhere herein.) (Computing device 408 is alternatively herein referred to as device 408.) Each device 408 is connectable to server 404 via network 406. Each device 408 may be operated by a respective user 410.

The type of each computing device 408 is not particularly limited. In a present embodiment, device 408 is a computer connected to a virtual reality (VR) headset device 408-1, a smart refrigerator device 408-2 and a workstation 408-n at a call center. Computing device 408 can also be any device that can receive voice input and be controlled to provide, for example, an output response.

Each device 408 is generally configured to receive voice input from a respective user 410. Each device 408 is also configured to receive a response from server 404. Each response is based on an affective analysis of the voice input, which in system 100 is performed by server 404. As will be discussed in greater detail below, the response can lead to controlling the respective computing device 408 based on the affective analysis.

The central server 404 also maintains within local memory at least one dataset 412. According to a present embodiment, dataset 412 comprises a history log 412-1 that keeps track of all current and all previous input emotion and responses, a response library 412-2 comprising previously derived and stored conversation graphs including optimal responses to speech and a plurality of emotion classifiers 412-3 including predetermined weighting coefficients for primary and secondary emotions. While the present embodiment refers to specific datasets 412, it is to be understood that these datasets are merely exemplary types of datasets that can be incorporated into the present specification, and that other types of datasets may also be incorporated. Furthermore, the example datasets 412 can be combined or structured differently than the present embodiment. Datasets 412 will be discussed in greater detail below.

The central server 404 also maintains within local memory at least one application 414 that is executable on a processor within server 404 and the at least one dataset 412 is accessible to at least one of the executing applications 414. As will be discussed in greater detail below, applications 414 perform the artificial intelligence training as well as the affective analysis of the voice inputs received from each computing device 408 and generates a response that enables the control of computing device 408. The example applications 414 can be combined or structured differently than the present embodiment.

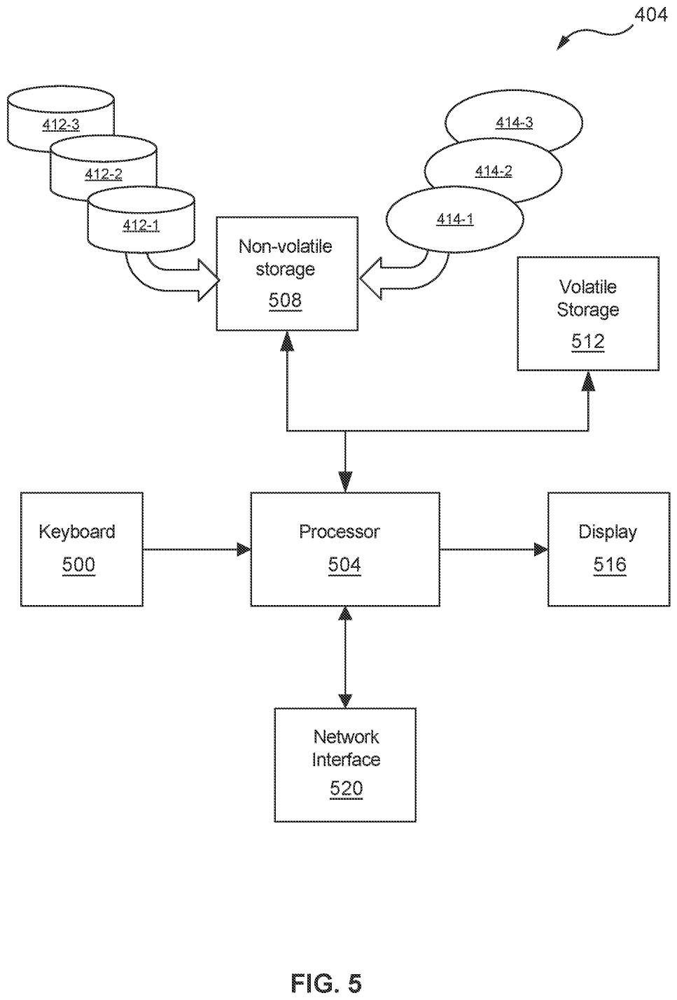

Referring now to FIG. 5, a non-limiting example of server 404 is shown in greater detail in the form of a block diagram. While server 404 is depicted in FIG. 2 as a single component, functionality of server 404 can be distributed amongst a plurality of components, such as a plurality of servers and/or cloud computing devices, all of which can be housed within one or more data centers. Indeed, the term “server” itself is not intended to be construed in a limiting sense as to the type of computing hardware or platform that may be used.

Server 404 includes at least one input device in which a present embodiment includes a keyboard 500. (In variants, other input devices are contemplated.) Input from keyboard 500 is received at a processor 504. In variations, processor 504 can be implemented as a plurality of processors. Processor 504 can be configured to execute different programing instructions that can be responsive to the input received via the one or more input devices. To fulfill its programming functions, processor 504 is configured to communicate with at least one non-volatile storage unit 508 (e.g., Erasable Electronic Programmable Read Only Memory (“EEPROM”), Flash Memory) and at least one volatile storage unit 512 (e.g., random access memory (RAM). Programming instructions (e.g. applications 414) that implement the functional teachings of server 404 as described herein are typically maintained, persistently, in non-volatile storage unit 508 and used by processor 504 which makes appropriate utilization of volatile storage 512 during the execution of such programming instructions.

Processor 504 in turn is also configured to control display 516 and any other output devices that may be provided in server 404, also in accordance with different programming instructions and responsive to different input received from the input devices.

Processor 504 also connects to a network interface 520, for connecting to network 406. Network interface 520 can thus be generalized as a further input/output device that can be utilized by processor 504 to fulfill various programming instructions.

As will become further apparent below, server 404 can be implemented with different configurations than described, omitting certain input devices, or including extra input devices, and likewise omitting certain output devices or including extra output devices. For example, keyboard 500 and display 516 can be omitted where server 404 is implemented in a data center, with such devices being implemented via an external terminal or terminal application that connects to server 404.

In a present embodiment, server 404 is configured to maintain, within non-volatile storage 508, datasets 412 and applications 414. Datasets 412 and applications 414 can be pre-stored in non-volatile storage 508 or downloaded via network interface 520 and saved on non-volatile storage 508. Processor 504 is configured to execute applications 414, which accesses datasets 412, accessing non-volatile storage 508 and volatile storage 512 as needed. As noted above, and as will be discussed in greater detail below, processor 504, when executing applications 414, performs the affective analysis of voice inputs received from device 408, via network interface 520, and generates a response that enables the control of device 408.

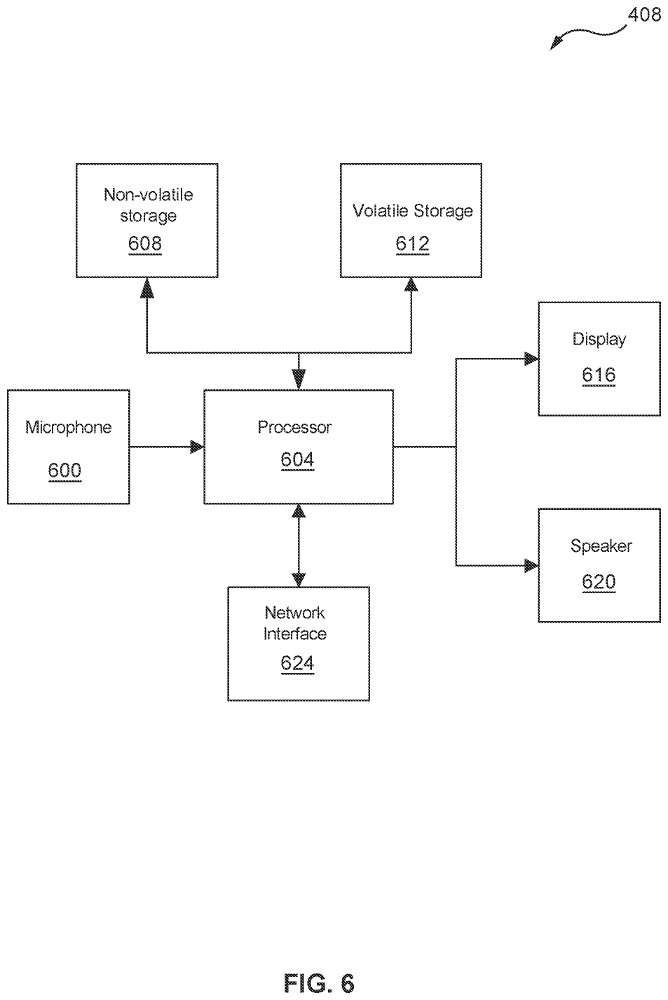

Referring now to FIG. 6, a non-limiting example of device 408 is shown in greater detail in the form of a block diagram. Device 408 includes at least one input device, which in a present embodiment includes microphone 600. As noted above, other input devices that receive sound are contemplated. Input from microphone 600 is received at processor 604. In variations, processor 604 may be implemented as a plurality of processors. Processor 604 can be configured to execute programming instructions that are responsive to the input received via microphone 600, such as sending audio received via microphone 600 to server 404. To fulfill its functions, processor 604 is also configured to communicate with at least one non-volatile storage-unit 608, (e.g., EEPROM or Flash Memory) and at least one volatile storage unit 612. Programming instructions that implement the functional teachings of device 408 as described herein are typically maintained, persistently, in non-volatile storage unit 608 and used by processor 604 which makes appropriate utilization of volatile storage 612 during the execution of such programming instructions.

Processor 604 is also configured to control display 616 and speaker 620 and any other output devices that may be provided in device 408, also in accordance with programming instructions and responsive to different input from the input devices.

Processor 604 also connects to a network interface 624, for connecting to network 406. Network interface 624 can thus be generalized as a further input/output device that can be utilized by processor 604 to fulfill various programming instructions.

As will become further apparent below, device 408 can be implemented with different configurations than described, omitting certain input devices, or including extra input devices, and likewise omitting certain output devices or including extra output devices. (In variations of the present embodiments, the functionality of device 408 and sever 404 can be combined into a single device, such as by incorporating the functionality of server 404 directly into device 408.)

Processor 604 is configured to send input such as one or more voice messages to server 404, via network interface 624, accessing non-volatile storage 608 and volatile storage 612 as needed. Processor 604 is also configured to receive a determined affective categorization of the voice message from server 404 and configured to control one or more of the output devices of device 408 according to the determined affective categorization.

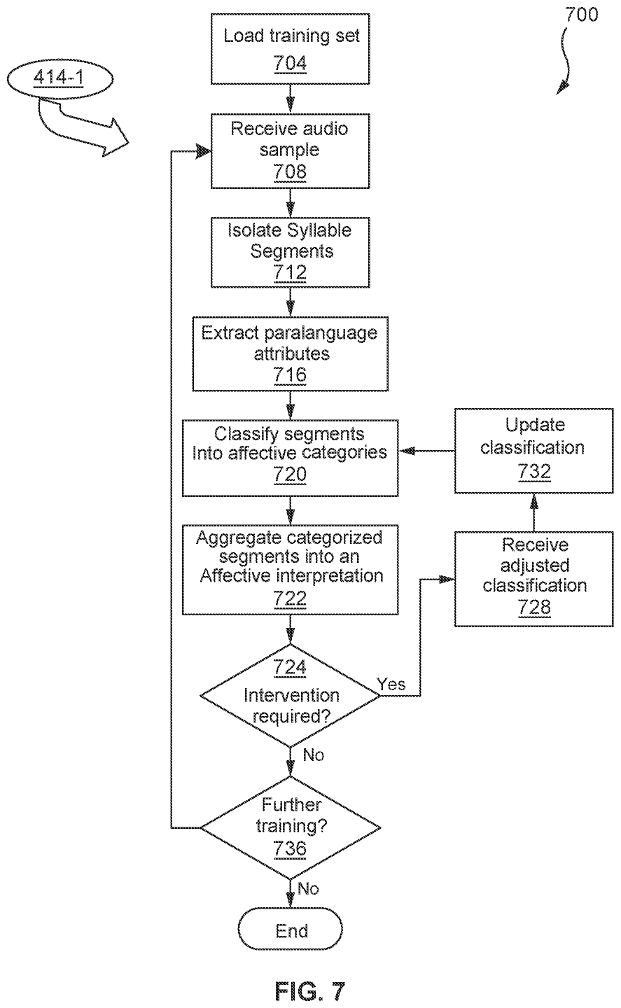

To further assist in understanding system 400, reference will now be made to FIG. 7 which shows a flowchart indicated generally at 700, depicting a method to train certain artificial intelligence (AI) used in system 400. Hereafter, the flowchart will be referred to as method 700, and this nomenclature will apply to other methods and flowcharts discussed herein. Method 700 can be implemented on system 400, but it is to be understood that method 700 can also be implemented on variations of system 400, and likewise, method 700 itself can be modified and operate on system 400. It is to be understood that the blocks in method 700 need not be performed in the exact sequence shown and that some blocks may execute in parallel with other blocks, and method 700 itself may execute in parallel with other methods. Additional methods discussed herein in relation to system 400 are subject to the same non-limiting interpretation.

For illustrative convenience, method 700 will now be discussed in relation to system 400, and the integration of method 700 into system 400 is represented by the inclusion of application 414-1 in FIG. 7, indicating that method 700 is implemented as application 414-1 in FIG. 4. Thus, method 700 and application 414-1 may be referred to interchangeably, and this convention will also apply elsewhere in this specification.

In a present implementation, method 700 comprises a method of affective computing used to train a processor to receive voice samples and classify the samples according to their respective affective categories, also herein referred to as the artificial intelligence training exercise.

Block 704 comprises loading a training set. The training set comprises a plurality of voice samples, each associated with an emotional interpretation. In relation to system 400, the training set can be maintained in dataset 412-1. For example, a training set can be based upon an audio recording database such as the Ryerson Audio-Visual Database of Emotional Speech and Song (“RAVDESS”) (Livingstone S R, Russo F A (2018) The Ryerson Audio-Visual Database of Emotional Speech and Song (RAVDESS): A dynamic, multimodal set of facial and vocal expressions in North American English. PLOS ONE 13(5): e0196391. https://doi.orell 1.132 oturmal.pone.0196391) or Crowd-Sourced Emotional Multimodal Actors Dataset (“CREMA-D”) (Cao H, Cooper D G , Keutmann M K, Gur R C, Nenkova A, Verma R. CREMA-D: Crowd-sourced Emotional Multimodal Actors Dataset. IEEE Trans Affect Comput. 2014; 5(4):377-390. doi: 10.1109/TAFFC.2014.2336244). RAVDESS is a validated multimodal database of emotional speech and song. The database is gender balanced consisting of 24 professional actors, vocalizing lexically matched statements in a neutral North American accent. RAVDESS contains 7356 samples (total size: 24.8 GB). The database contains 24 professional actors (12 female, 12 male), vocalizing two lexically matched statements in a neutral North American accent. The recorded speech includes calm, happy, sad, angry, fearful, surprise, and disgust expressions, and the recorded song contains calm, happy, sad, angry, and fearful emotions. Each expression is produced at two levels of emotional intensity (normal, strong), with an additional neutral expression. All conditions are available in three modality formats: Audio-only (16 bit, 48 kHz .wav), Audio-Video (720p H.264, AAC 48 kHz, .mp4), and Video-only (no sound). CREMA-D is a data set of 7,442 original samples from 91 actors. These samples were taken from 48 male and 43 female actors between the ages of 20 and 74 coming from a variety of races and ethnicities (African America, Asian, Caucasian, Hispanic, and Unspecified). Actors spoke from a selection of 12 sentences. The sentences were presented using one of six different emotions (Anger, Disgust, Fear, Happy, Neutral and Sad) and four different emotion levels (Low, Medium, High, and Unspecified). Participants rated the emotion and emotion levels based on the combined audiovisual presentation, the video alone, and the audio alone. Due to the large number of ratings needed, this effort was crowd-sourced and a total of 2443 participants each rated 90 unique samples, 30 audio, 30 visual, and 30 audio-visuals. 95% of the samples have more than 7 ratings. It is to be understood that the foregoing are non-limiting examples, and alternatively, any other training set comprising a plurality of voice samples and associated emotional interpretations may be used.

Block 708 comprises receiving a single voice sample from the training set. In relation to system 400, a single voice sample from dataset 412-1 may be loaded into processor 504 as it is executing application 414-1. Note that each received voice sample is also accompanied by an associated emotional interpretation (such as an emotion and an emotion level) as previously discussed.

Block 712 comprises isolating syllable segments of the voice sample. Isolating syllables is analogous to isolating notes in a musical composition, speech being expressed from syllable to syllable. Each syllable has an associated note attached with regards to how it is perceived. Isolating voice samples into syllables allows for an accurate assessment of the emotion(s) expressed in the voice sample, as well as the manner in which speech moves from one emotion to the other. For example, to isolate syllable segments, open-source voice parsing software may be used, such as Praat (Paul Boersma & David Weenink (1992-2022): Praat: doing phonetics by computer [Computer program] Version 6.2.06, retrieved 23 Jan. 2022 from https://www.praat.org). or Open-source Speech and Music Interpretation by Large-space Extraction (OpenSMILE) (Eyben, Florian & Wöllmer, Martin & Schuller, Björn. (2010). openSMILE—The Munich Versatile and Fast Open-Source Audio Feature Extractor. MM′10—Proceedings of the ACM Multimedia 2010 International Conference. 1459-1462. 10.1145/1873951.1874246). Praat is a freeware program for the analysis and reconstruction of acoustic speech signals and offers a wide range of standard and non-standard procedures, including spectrographic analysis, articulatory synthesis, and neural networks. OpenSMILE is opensource software to support real-time speech and emotion analysis components. OpenSMILE is a toolkit for audio feature extraction and classification of speech and music signals. Toolkits such as Praat or OpenSMILE are employ techniques for decomposing syllables for more refined acoustic sound evaluations. It is to be understood that the foregoing are non-limiting examples, and alternatively, any other voice parsing method may be used to the isolate syllable segments of the voice sample.

Block 716 comprises extracting paralanguage attributes from the resultant syllable segments (or other parsing method) taken from block 712. Paralanguage attributes can include paralinguistic properties of speech that modify meaning or convey emotion through various speech techniques such as volume, tone, melody, pitch and pace. Extracting paralanguage attributes at block 716 is accomplished by applying the five components of paralanguage attribute scoring method (to be discussed in more detail below) to the voice sample to train a neural network or a convolutional neural network to identify paralanguage attributes to secure a predictive emotional score. For example, Hidden Unit Bidirectional Encoder Representations from Transformers (HuBERT) (Hsu, Wei-Ning & Bolte, Benjamin & Tsai, Yao-Hung & Lakhotia, Kushal & Salakhutdinov, Ruslan & Mohamed, Abdelrahman. (2021). HuBERT: Self-Supervised Speech Representation Learning by Masked Prediction of Hidden Units. IEEE/ACM Transactions on Audio, Speech, and Language Processing. PP. 1-1. 10.1109/TASLP.2021.3122291). may be employed to identify the paralanguage attributes. HUBERT is a machine learning technique developed by Facebook AI research (“FAIR”) for learning self-supervised speech representations. HuBERT utilizes an offline k-means clustering algorithm and learns the structure of its input by predicting the right cluster for masked audio segments. HuBERT also employs FAIR's DeepCluster method for self-supervised visual learning. DeepCluster is a clustering method that learns a neural network's parameters and their cluster assignment, after which it groups these features using a standard clustering algorithm, known as k-means. The HuBERT model learns both acoustic and language models from these continuous inputs. For this, the model first encodes unmasked audio inputs into meaningful continuous latent representations. These representations map to the classical acoustic modelling problem. The model then makes use of representation learning via Masked Prediction. The model seeks to reduce prediction error by capturing the long-range temporal relationships between the representations it has learned. The consistency of the k-means mapping from audio inputs to discrete targets allows the model to focus on modelling the sequential structure of input data. For instance, if an early clustering utterance cannot tell/k/and /g/sounds apart, it would lead to a single supercluster containing both these sounds. The prediction loss will then learn representations that model how other consonant and vowel sounds work with this supercluster while forming words. A Convolutional Neural Network (CNN) may also be used to extract paralanguage attributes from the syllable segments. A CNN is a class of neural networks that specializes in processing data that has a grid-like topology. Each neuron in a CNN processes data only in its receptive field. The layers are arranged in such a way so that they detect simpler patterns first (lines, curves, sounds etc.) and more complex patterns (faces, objects, string of sounds, etc.) further along. This technique can be applied to audio as well in accordance with the teachings of the present specification.

It is to be understood that the foregoing are non-limiting examples, and alternatively, any other machine learning technique may be used to train the processor 504 to extract paralanguage attributes from the syllable segments, such as NLP methods to extract meaning and context, using methods from Bidirectional Encoder Representations from Transformers (“BERT”) (BERT: Pre-training of Deep Bidirectional Transformers for Language Understanding https://doi.org/10.48550/arXiv.1810.04805) or Generative Pre-trained Transformer 3 (“GPT-3”) (https://openai.com/blog/gpt-3-apps/) open source NLP toolkits, or any other methods that will be apparent to those skilled in the art.

Block 720 comprises classifying the segments, with their paralanguage attributes extracted from block 716, into affective categories. The affective categories can be based on an identification of the paralanguage attributes. The affective categories may consist of subcategories, such as a primary emotion category, and a secondary emotion category. Primary emotions may include, but are not limited to fear, disgust, anger, surprise, happiness, sadness. Classifying the segments may be accomplished by assigning one or more numerical values to each of the paralanguage attributes.

Block 722 comprises aggregating the affective categories into an affective interpretation. The aggregation can be accomplished through a summation of the affective categories, as previously discussed in relation to block 720. More particularly, the values assigned to each of the paralanguage attributes at block 720 are combined using a set of predetermined weighting coefficients for each of the primary emotions into an emotional vocal score to determine the most strongly registered emotion. (In accordance with a variant of the present embodiment, the classifying can continue to additional (secondary, tertiary, etc.) emotions, such as classifying, the segments into secondary emotions such as, but not limited to: embarrassment, excitement, contempt, shame, pride, satisfaction, amusement.) Once these attributes have been identified in the voice sample, and a score is assigned to each attribute (e.g., a score from about 0-10 is assigned to each attribute of the five components of paralanguage attributes—pitch, pace, tone, melody, and volume), the classification of which affective category the voice sample belongs, based on the assigned scores, will become apparent through the aggregation. It is to be understood that the scoring method is a non-limiting example, and different ranges and levels of precision (i.e. number of significant digits) of scores may be assigned to each attribute, as will become apparent to those skilled in the art. The scoring method, itself, will be discussed in further detail below.

Block 724 comprises determining whether any intervention is required. The criteria for such a determination are not particularly limited, but it is contemplated that a human or a neural network can examine the resulting output of the artificial intelligence algorithm at block 720 and block 722 for anomalies. For example, the criteria at block 724 can ascertain whether the affective category classification at block 720 had any statistical anomalies. Alternatively, or in addition, the criteria at block 724 can ascertain whether the affective interpretation at block 722 matches the associated emotional interpretation that accompanied the voice sample received at block 708.

A “yes” determination at block 724 leads to block 728, at which point the human trainer (or neural network) adjusts the classification from block 720 to align the classification with the emotional interpretation. By way of example, a “yes” determination may be made at block 724 when method 700 is repeated for several different training sets to provide even further training for subsequent use in method 900 or method 1000. (Likewise, when review of the specification is complete by a person of skill in the art, it will become apparent that method 900 and method 1000 can be modified to provide opportunities for additional human training by the actual user of a given device 408). To elaborate, method 700 can be performed once for the RAVDESS training set and again for the CREMA-D training set. In this case a “yes” determination at block 724 can be made where there is a need to normalize the categorizations between the different training sets through human intervention at block 728. As another example, a “yes” determination can also be made at block 724 when the classification at block 720 or an aggregation at block 722 leads to an ambiguous result, such as obtaining a classification at block 720 that statistically deviates from a prior training loop through method 700, or an affective interpretation at block 722 that contradicts a prior emotional interpretation provided with the sample. (A person of skill in the art will now appreciate that a chosen level of precision for block 720 and block 722 can impact the determination as to whether or not a particular result is ambiguous, but at the same time finding a balance between a degree of precision and an accurate categorization of emotion can be based on the availability of computing resources within system 100, and thus a person of skill in the art will now appreciate one non-limiting aspect of how the present teachings can provide a means for affective computing that optimizes the amount of available computing resources balanced against accurate categorizations.)

Thus, block 728 comprises receiving an updated classification. Block 728 can be achieved according to artificial intelligence training processes by providing an interpretation of the classifications at block 720 or the aggregation at block 722 that is consistent with the emotional interpretation provided with the sample; or, where such consistency cannot be achieved, deleting the sample from the training set altogether as an unresolvable statistical outlier. Block 728 can be performed by a human or a neural network that itself has been trained to spot such outliers. Block 732 comprises updating the classification based on the input received at block 728, at which point method 700 returns to block 720. (In variations, method 700 can proceed directly from block 732 to block 736 where the updating of the classification at block 732 is sufficient and the need to perform block 720 again is effectively obviated)

If, at block 724, it is determined that no further validation of the classified voice sample is required, then, at block 736 a determination is performed as to whether further training of the samples within the training set is required. If there are remaining voice samples to be classified, then the method will restart again at block 708. If all the voice samples have been classified, then method 700 terminates.

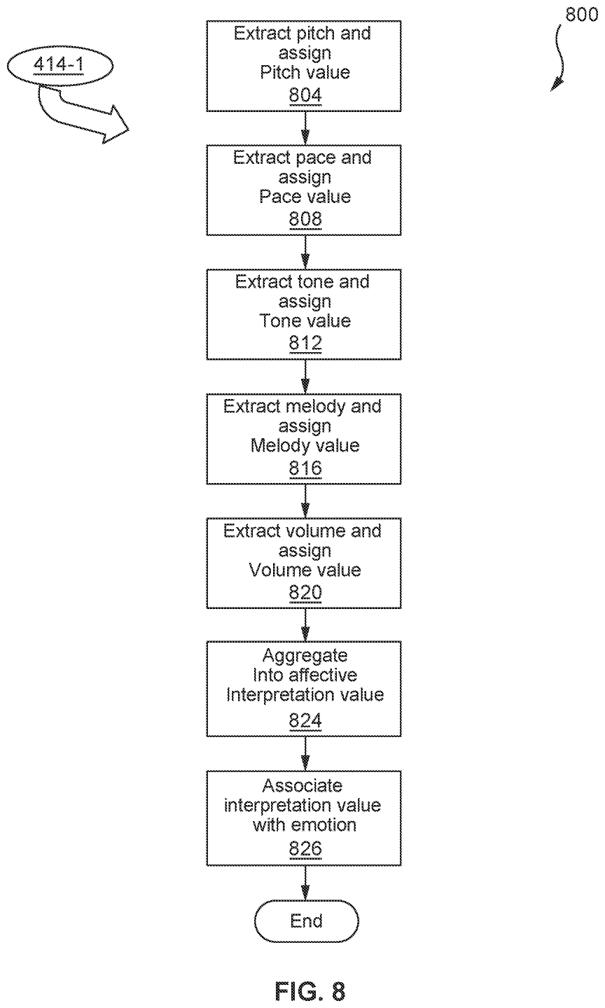

To further assist in understanding system 400, reference will now be made to FIG. 8, which shows a flowchart indicated generally at 800, depicting a method that expands upon blocks 720 and 722 from FIG. 7. Specifically, method 800 is a method for classifying syllable segments into affective categories and subsequently aggregating the categorized segments into an affective interpretation, i.e., an emotion.

In a present implementation, method 800 comprises a method of affective computing used to extract, at a processor, sound elements to classify audio segments according to their respective affective categories.

Block 804 comprises extracting pitch from an audio segment and assigning a pitch value to the segment. Pitch is defined as the main musical note that a segment hovers within and is repeated most often. In a present example embodiment, pitch is assigned a value of 1-10, with 1 being the lowest and 10 being the highest. It will become evident to those skilled in the art that any other scale may be used (rather than a 1-10 scale) to assign pitch values, and this applies to any other scale ranges referred to hereafter.

Block 808 comprises extracting pace from the audio segment and assigning a pace value to the segment. Pace is defined as how fast or how slow the spoken words in the audio segment are perceived. This can also be measured as beats per minute (“BPM”). Pace is measured from syllable to syllable, and from word to word. The silence in between words is also considered. In the present example embodiment, pace is assigned a value of 1-10, with 1 being the slowest and 10 being the fastest.

Block 812 comprises extracting tone from the audio segment and assigning a tone value to the segment. Tone is defined to be how airy or how edgy the spoken words in the audio segment are perceived. When air comes out of the lungs it is partially obstructed by the vocal cords. If the vocal cords are in a short and wider position, more air is blocked from exiting the mouth. If the vocal cords are longer and thinner, more air exits the mouth and becomes audible sound. In the present example embodiment, tone is assigned a value of 1-10, with 1 being the airiest—the vocal cords allowing the maximum amount of air to pass through and 10 being the edgy—the vocal cords blocking a great deal of the air and only allowing a small amount through. The sound of airy and edgy are very different tonally, based on the sounds of the more or less air exiting the mouth attached to the spoken words.

Block 816 comprises extracting melody from the audio segment and assigning a melody value to the segment. Melody is defined as the pattern of notes, from one note to another (i.e., ascending, descending, or monotone), as well as the interval range between the lowest note and the highest note, and the number of different notes within an audio segment. In the present embodiment, melody comprises three different values, with a pitch range being assigned a value from 1-10, a count of the number of notes, and a slope value of: a)−1 for overall descending melody; b) 0 for a monotone melody; c) or +1 for an ascending melody.

Block 820 comprises extracting volume from the audio segment and assigning a volume value to the segment. Volume is defined as how loud or how soft the audio segment is perceived to be. Volume may be measured as decibels (dB). In the present embodiment, volume is assigned a value of 1-10, with 1 being the softest and 10 being the loudest. To convert dB values to a 1-10 scale, the average range dB volume of each voice may be taken and divided into 10 measured parts.

To reiterate, a human trainer and/or a neural network can be employed to assign the various numerical ranges indicated above.

Block 824 comprises aggregating each of the values from block 804 to block 820 to provide an affective interpretation value. This may be done through a summation equation, as discussed earlier and reproduced here for clarity: B_{c}=K_{Pi}Aₚᵢ+K_{Pa}A_{Pa}+K_{T0}A_{T0}+K_{V0}A_{V0}+K_{Mel.Asc}A_{Mel.Asc}+K_{Mel.Desc}A_{Mel.Desc}+K_{Mel.Mon}A_{Mel.Mon}, where Be is the emotion and K_{Pi}, K_{Pa}. K_{T0}. K_{V0}. K_{Mel.Asc}.K_{Mel.Desc}.K_{Mel.Mon} are the model weighting coefficient sets derived from the training system model using pre-recorded voice clips. Furthermore, the “A” values are the extracted value from the given segment for each of pitch, pace, tone, melody and volume.

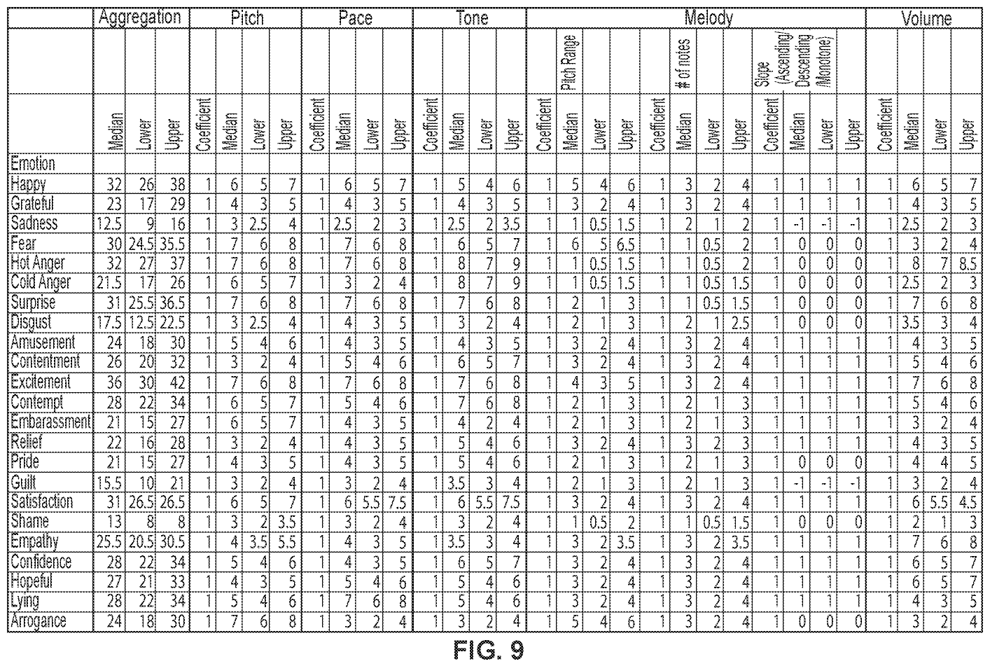

Block 826 comprises associating the resulting affective interpretation value with an emotion. An example of the values assigned to each emotion from block 804 to block 816 can be seen in FIG. 9. In this example dataset, the values are displayed before the initial performance of method 700, and where all model weighting coefficients are set to 1. In this example embodiment, happy is assigned a pitch value of 6, a pace value of 6, a tone value of 6, a melody value of 9 (aggregation of a pitch range of 5, 3 notes, and an ascending value of 1). These values are determined through an analysis of the happy emotion. When one is happy, they are energetic, have a strong pulse, and a slightly elevated heart rate. A happy individual will feel bolder, more confident, and enthusiastic. An increased volume is a byproduct of these feelings. Happiness comprises an ascending melody, as an ascending melody is perceived to be joyful. Additionally, when an individual is happy, the pace at which they tend to speak is increased. The aggregation of these specific values together will always produce happiness as the determined emotion. While the same value may be produced for another emotion, as can be seen in FIG. 9, for example, with hot anger aggregating the same overall value as happiness, however, what is of importance is the way that value was aggregated, with the difference in pitch values, pace values, tone values, melody values and volume values.

As a further example from FIG. 9, sadness is assigned a pitch value of 3, a lower-end pace, tone, and volume value of 2 respectively, a median pace, tone and volume value of 2.5, respectively and a higher-end pace, tone and volume value of 3, respectively. Sadness is also assigned an overall melody value of 2, being the aggregate of a 1 pitch range, 2 notes, and a−1 (descending) monotone. These values are determined through an analysis of the sad emotion. When an individual is sad, they have lower energy. The sad individual's lack of physical and emotional strength creates sounds that imitate weakness and lack of hope. A sad individual will have less melody, as they will sound monotone at times but usually speak in a descending scale. A sad individual will speak slower, and at a much softer volume, as well as at a low pitch, at the very bottom of that individual's range.

FIG. 9 further displays the values of common example emotions, such as Gratefulness, Fear, Hot Anger, Cold (restrained) Anger, Surprise, Disgust, Amusement, Contentment, Excitement, Contempt, Embarrassment, Relief, Pride, Guilt, Satisfaction, Shame, Empathy, Confidence, Hopeful, Lying, and Arrogance.

FIG. 9 also includes a plurality of weight coefficient values, which are initially set to “1” at the beginning of method 700, but which iteratively are adjusted up or down during each pass through the set of samples being processed, to provide an alignment between the emotion associated with a given sample, and the emotion that is determined to result from the summation of the extracted values from the voice sample.

To elaborate further, the Table in FIG. 9 represents a presently known and presently preferred set of seed data to begin performance of method 700 to be used in association with the voice samples associated with the training set (or training sets) received at block 704. As method 700 is performed, each of the values in FIG. 9 including the coefficients are iteratively adjusted until a unique range of lower and upper aggregated values are achieved, such that a voice sample that falls within such a range can be correlated to a given emotion. Likewise, in a variant, the upper and lower values for each emotion for each paralanguage attribute can also be adjusted until unique ranges of upper and lower aggregated values are achieved.

A person of skill in the art will now recognize that the chart in FIG. 9 is merely an example and that the numbering scale, level of precision, types of paralanguage attributes and weighting coefficients can be modified, and such modifications are within the scope of the present disclosure.

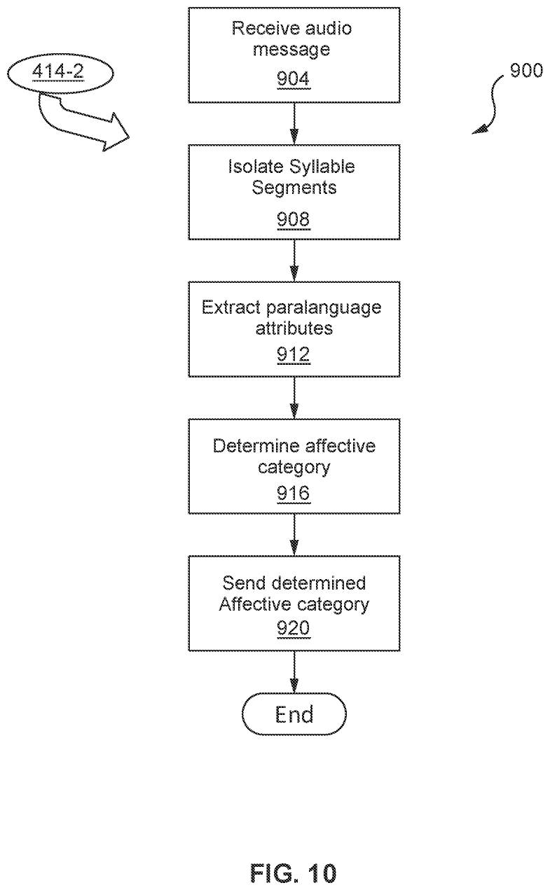

To further assist in understanding system 400, reference will now be made to FIG. 10, which shows a flowchart indicated generally at 900, depicting a method of operating server 404 to receive audio input from device 408, determine the affective categorization associated with the audio input, and send this categorization back to device 408.

For illustrative convenience, method 900 will now be discussed in relation to system 400, and the integration of method 900 into system 400 is represented by the inclusion of application 414-2 in FIG. 10, indicating that method 900 is implemented as application 414-2 in FIG. 4. Thus, method 900 and application 414-2 can be referred to interchangeably.

In a present implementation, method 900 comprises a method of affective computing used to receive, at a processor, voice messages, classify the messages according to their respective affective categories, and send the classified messages back to a device.

Block 904 comprises receiving a voice message from a device 408. The voice message consists of a captured voice of a user of device 408, which is to be affectively categorized so that device 408 can be controlled according to a response determined by server 404. The voice message may be in any format, such as MPEG-1 Audio Layer 3 (MP3), Waveform Audio File Format (WAV), or any other format that will be apparent to those skilled in the art.

Block 908 comprises isolating syllable segments. Block 908 is analogous to Block 712. The same manner of isolating syllable segments in Block 712 generally applies to Block 908. However, the difference is that, in Block 908, the voice sample is taken from a user of device 408 rather than a training set. This will apply to further blocks of method 900 that are analogous to blocks in training method 700.

Block 916 comprises determining the affective categorization of the voice sample. Block 908 is analogous to Block 720 and 722 of training method 700.

Block 920 comprises of sending the determined affective categorization from Block 916 back to device 408. The operation of device 408 with respect to method 900 will be discussed below, as its own method 1000.

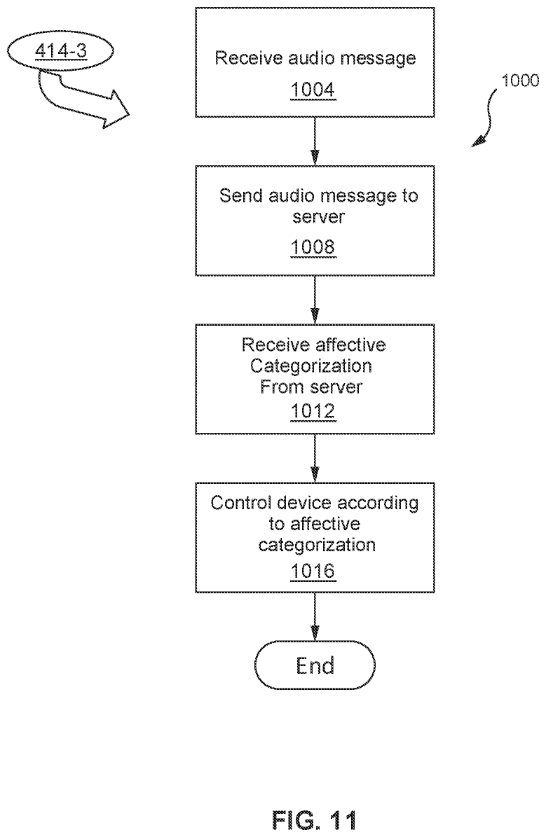

To further understand the operation of device 408, reference will now be made to FIG. 11, which shows a flowchart indicated generally at 1000, depicting a method for controlling a device based on a computed affective categorization. Method 1000 configures device 408 to receive audio input and send that audio input to server 404, receive the affective categorization associated with the audio input, after which device 408 is controlled according to said affective categorization.

For illustrative convenience, method 1000 will now be discussed in relation to system 400, and the integration of method 1000 into system 400 is represented by the inclusion of application 414-3 in FIG. 11, indicating that method 1000 is implemented as application 414-3 in FIG. 4. Thus, method 1000 and application 414-3 may be referred to interchangeably.

Block 1004 comprises receiving a voice message. The voice message may be received in various ways. As previously discussed, device 408 may be a computer 408-1 connected to a virtual reality (VR) headset device. The voice message can be received through a microphone on the headset. The voice message may comprise, for example, a request to order a pizza through a virtual reality environment. Device 408 may alternatively be a smart refrigerator 408-2. The voice message can be received through a microphone on the smart refrigerator, and may comprise, for example, a request for the fridge to provide food or beverage items. Further, device 408 may be a workstation 408-3 at a call center. The voice message may be received through a telephone call to the call center workstation and may comprise of a request for customer service. It will be apparent to persons of skill in the art that the foregoing examples are non-limiting, and device 408 may be any other device that receives voice messages.

Block 1008 comprises sending the captured voice message to a server, such as server 404. The voice message can be sent from device 408 to server 404 through a network, such as network 406.

Block 1012 comprises receiving the affective categorization (as completed in method 900) from server 404. Again, the affective categorization can be sent from server 404 to device 408 through network 406.

Block 1016 comprises device 408 being controlled according to the received affective categorization. Device 408 may, for example, be controlled to provide an appropriate response to an angry customer, in the example embodiment where device 408 is a computer connected to a VR headset device or a workstation at a call center. In the example embodiment where device 408 is a smart refrigerator that may provide food or beverage items, a user may walk to the refrigerator and request an ice-cream. According to our specific example, consider that the refrigerator may be equipped with a water bottle dispenser and an ice cream cone dispenser, such as is commonly associated with certain vending machine functionality. The smart refrigerator may also be configured to try and assist the user with weight control. In this example, the smart refrigerator will then receive the affective categorization of voice message and will be controlled to respond appropriately. For example, if the affective categorization of the voice message determines boredom, the smart refrigerator can be controlled to generate a message that affirms the detected categorization of boredom and not necessarily hunger. The smart refrigerator can, in this example, dispense a bottle of water so as to assist the user with ingestion of unnecessary calories. As another example, should the affective categorization result in a detection of a sad emotion, the smart refrigerator will be controlled to dispense the ice cream and provide a supportive message in response, such as “I am sorry you are feeling sad”. It will be apparent to the person skilled in the art that the above examples are non-limiting, and any device which is configured to receive an voice message and generate a response message and/or otherwise control the device accordingly is contemplated.

As will now be apparent from this detailed description, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot transmit or receive electronic messages, cannot control a display screen, cannot implement a machine learning algorithm, nor implement a machine learning algorithm feedback loop, and the like).

In the foregoing specification, specific embodiments have been described. However, one of ordinary skill in the art will now appreciate that various modifications, combinations and subsets can be made without departing from the scope of the invention. For example, the number of paralanguage attributes used in the training and in the use of the system may vary. For example, a voice message may be classified using fewer, such as four, paralanguage attributes rather than five. Additionally, in a further exemplary embodiment, melody may be comprised of only a pitch range and a slope value, with the exclusion of the number of notes. This can also result in less bandwidth and memory usage. Using fewer paralanguage attributes to classify a voice message can result in less bandwidth and memory use, and yet still provide a sufficiently accurate affective categorization. Where it is possible to use fewer attributes to conserve such computing resources, as person of skill in the art will now recognize certain technological efficiencies afforded by the present specification. The number of attributes that are chosen can be dynamic according to the availability of computing resources. Likewise, the degree of precision (i.e. the number significant digits) associated with each paralanguage attribute can be chosen to also optimize the amount of available computing resources such as processing speed, memory, and bandwidth. The AI or neural network training models can learn which degree of precision has sufficient accuracy for a given computing device application.

In another example, the user may take part in the neural network training to enhance the response capabilities of the system. For example, in conversation, an empathetic listener will often respond in an empathetic manner. Taking empathetic responses into account to train the system will allow the system to respond similarly and may also allow for a verification of affective categorization. For example, if an input message to a smart refrigerator results in an affective categorization of “sad” by the system, the smart refrigerator may respond with “it sounds like you're feeling sad, did I get that right?”. In the event that the user believes the affective categorization was wrong, and the voice message should have been categorized as “bored” instead, then the user can provide this perception back into the training loop of the neural network. An additional human verification of the user's perception before permitting the user's perception to be fed back into the training model is also contemplated.

As another example, it is to be understood that, in variations, the various methods can be performed in entirely one computing device or across a plurality of computing device. For example, all of the methods can be performed entirely within a given device 408.

As another example, it is also contemplated that the teachings herein can be applied towards influencing the emotional state of a user interacting with a given device 408. To elaborate, it is contemplated that system 400, via, for example, device 408-1 can be configured to engage in an emotional dialogue with the user. Device 408-1 can be configured to have the objective of observing a “happy” emotional response in the user. If the initial detected emotion is “sad”, then using the methods herein, the output device of device 408-1 can be controlled to engage in dialogue with the user to nudge the user from the “sad” state to the “happy” state. Since these are opposite states, a concept of a “staircase” of interactive responses between user 412 and device 408 whereby the response to the user 412 initially mirrors the emotion of user 412 but with an affect that is slightly above sad but does not quite reflect happy. The response of user 412 to the initial mirroring is detected to assess whether the user has moved the emotion from the “sad” state towards the happy state. System 400 thus iterates repeatedly until the detected emotion reflects a target state of “happy”, or until an exception is achieved causing the system to cease. The exception can be based on “giving up” after a certain number of iterations or any other criteria that will occur to those of skill in the art.

Accordingly, the specification and figures are to be regarded in an illustrative rather than a restrictive sense, and all variations and modifications are intended to be included within the scope of present teachings. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art. Furthermore, references to specific percentages should be construed as being “about” the specified percentage.

A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, embodiments can be implemented as a computer-readable storage medium having computer readable code stored thereon for programming a computer (e.g., comprising a processor) to perform a method as described and claimed herein. Any suitable computer-usable or computer readable medium may be utilized. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM, and a Flash memory. In the context of this document, a computer-usable or computer-readable medium may be any medium that can contain, store, communicate, propagate, or transport the program for use by or in connection with the instruction execution system, apparatus, or device.

Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and integrated circuits (ICs) with minimal experimentation. For example, computer program code for carrying out operations of various example embodiments may be written in an object-oriented programming language such as Java, Smalltalk, C++, Python, or the like. However, the computer program code for carrying out operations of various example embodiments may also be written in conventional procedural programming languages, such as the “C” programming language or similar programming languages. The program code may execute entirely on a computer, partly on the computer, as a stand-alone software package, partly on the computer and partly on a remote computer or server or entirely on the remote computer or server. In the latter scenario, the remote computer or server may be connected to the computer through a local area network (LAN) or a wide area network (WAN), or the connection may be made to an external computer (for example, through the Internet using an Internet Service Provider).

Persons skilled in the art will also now appreciate that frequent and dynamic updating of datasets 412 bolsters the affective categorization and device control benefits of system 400. Thus, constant monitoring of voice messages received at device 408 and affective categorization performed in server 404, and specifically at processor 504, coupled with applications that constantly assess associations with those voice messages and their respective affective categorizations, can lead to increased confidence intervals in the accuracy of the datasets 412 and accompanying affective categorization of method 700. Additionally, AI trainers or other individuals may periodically manually affirm or deny the accuracy of the classifications made at block 720 and the aggregation at block 722 by studying captured voice message samples and comparing their associated emotional interpretation. These affirmations or denials, via block 728 and block 732 can be fed back into dataset 412, particularly weighting coefficients, such as the K values in FIG. 9, (which may also be referred to as confidence interval data) such that the affective categorizations are accurate, thereby increasing the quality of datasets 412, and future determinations made at Block 724. Furthermore, the training can also result in adjustments to the A values in the FIG. 9. Accordingly, persons skilled in the art will now appreciate the novel machine learning aspect of the present specification. Furthermore, one or more machine learning algorithms for implementing a machine learning feedback loop (via block 724, block 728 and block 732 of method 700) for training the one or more machine learning algorithms may be provided, where the machine learning feedback loop comprises processing feedback indicative of an evaluation of K and A values from FIG. 9 maintained within datasets 412 as determined by the one or more machine learning algorithms.

Indeed, at block 732, the weighting coefficients “K” can be adjusted as part of feedback for ongoing training the one or more machine-learning algorithms to better determine these task-command relationships. Such training can further include factors that lead to such determinations, including, but not limited to, manually affirming or denying “yes” determination made at block 724. Such a training set may be used to initially train the one or more machine learning algorithms.

Further, one or more later determined weighting coefficients “K” can be labelled to indicate whether the later determined weighting coefficients, as generated by the one or more machine-learning algorithms, represent positive (e.g., effective) examples or negative (e.g., ineffective) examples.

For example, the one or more machine-learning algorithms may generate weighting coefficients, to indicate higher or lower levels of respective confidence in correctly associating a given voice message sample with a given affective category.

Regardless, when weighting coefficients in datasets 412 are provided to one or more machine-learning algorithms in the machine-learning feedback loop, the one or more machine-learning algorithms may be better trained to determine future weighting coefficients.

In other examples, weighting coefficients generated by one or more neural network or machine-learning algorithms may be provided to a feedback computing device (not depicted), which may be a component of the system 400 and/or external to the system 400 that has been specifically trained to assess accuracy of “yes” determination made at block 724. Such a feedback computing device may generate its own weighting coefficients as feedback (and/or at least a portion of the feedback, such as the labels) back to the server 404 for storage (e.g., at non-volatile storage 508) until a machine-learning feedback loop is implemented. Put another way, weighting coefficients for affective categorizations via a machine learning algorithm may be generated and/or provided in any suitable manner and/or by any suitable computing device and/or communication device.

Hence, by implementing a machine-learning feedback loop, more efficient operation of server 404 may be achieved, and/or a change in operation of the server 404 may be achieved, as one or more machine-learning algorithms are trained to better and/or more efficiently determine the confidence intervals in datasets 412.

As will now be apparent from this detailed description, the operations and functions of electronic computing devices described herein are sufficiently complex as to require their implementation on a computer system, and cannot be performed, as a practical matter, in the human mind. Electronic computing devices such as set forth herein are understood as requiring and providing speed and accuracy and complexity management that are not obtainable by human mental steps, in addition to the inherently digital nature of such operations (e.g., a human mind cannot interface directly with RAM or other digital storage, cannot control a display screen, cannot implement a machine learning algorithm, nor implement a machine learning algorithm feedback loop, and the like).

A person of skill in the art will now appreciate certain advantages that are provided by this specification. For example, detecting customer emotion in call center software operations may allow responses to customers to be generated that are perceived as sympathetic by the customer. This may serve to reduce customer dissatisfaction and customer churn, as referenced in US 2005/0170319 by Alberts and Love. A technical advantage afforded by detecting the emotion is that a workflow or script can be dynamically presented to the call center operator that is appropriate to the detected emotion. In this manner, local computing resources in the call center are more efficiently managed, as the call center operator does not need to manually select and search for the correct workflow or script corresponding to a given emotion; rather the computer workstation operated by the call center operator need only load the appropriate script into memory of the computer workstation and to generate that script on the screen. Thus the computer workstations' computing resources are more efficiently managed.

As previously discussed, the five components of paralanguage attributes, or the five building blocks of voice (Pitch, Pace, Tone, Melody and Volume) are examples of paralanguage attributes of affective speaking. The industry prior voice classifiers used in the art of affective computing do not include all five components of paralanguage attributes and respective methods, limiting their effectiveness in improving machine-to-human, or human-to-machine communication. The present specification therefore satisfies a need for a deep communication platform that augments human-machine communication with more accurate emotion intelligence to help guide the conversation to its desired outcome by detecting the human or machine emotional state and then offering the appropriate emotional response to the human or the machine

1. A method of affective computing, comprising:
receiving, at a processor, a captured voice message from an input device;
isolating, at the processor, syllable segments of the voice message;
extracting, at the processor, a set of paralanguage attributes of the voice message;
determining, at the processor, an affective categorization associated with the voice message;
sending, to an output device, the determined affective categorization of the voice message from the processor; and,
controlling the output device to respond to the voice message based on the determined affective categorization.

2. The method of claim 1 wherein the processor is located within a server.

3. The method of claim 1 wherein the input device and the output device are located within a computing device.

4. The method of claim 3 wherein the computing device is one of a VR headset, a smart refrigerator, a vending machine or a call center workstation.

5. The method of claim 4 wherein the vending machine comprises a plurality of types of dispensable articles and one of said types is dispensed via said output device based on a determined affective categorization.

6. The method of claim 1, wherein the paralanguage attributes comprise one or more of pitch, pace, tone, melody, and volume.

7. The method of claim 6 wherein the paralanguage attributes comprise all five of pitch, pace, tone, melody, and volume.

8. The method of claim 6 wherein each paralanguage attribute has a weighting coefficient associated therewith.

9. The method of claim 8 wherein said weighting coefficient is determined through an artificial intelligence training exercise comprised of receiving a plurality of voice samples and associated emotional interpretations and iteratively extracting each paralanguage attribute and aggregating a numerical value associated with each attribute into a summation that represents the affective categorization.

10. The method of claim 9 wherein the weighting coefficient for each said attribute is increased or decreased during each said iteration during said artificial intelligence training exercise.

11. An apparatus for affective computing comprising:
an interface for receiving a voice message including a plurality of syllable segments;
a processor connected to said interface and for isolating said syllable segments and extracting a set of paralanguage attributes therefrom; said processor configured to determine an affective categorization of said voice message and to send a control signal including said affective categorization via said interface.

12. The apparatus of claim 11 wherein said apparatus is a server and said interface is connectable to a computing device having a microphone for capturing said voice message; said computing device further having an output device for responding to said control signal.

13. The apparatus of claim 11 wherein said apparatus is a computing device and said interface includes a microphone and an output device; said microphone for capturing said voice message; said output device for responding to said control signal.

14. The apparatus of claim 13 wherein said computing device is one of a VR headset, a smart refrigerator, a vending machine or a call center workstation.

15. The apparatus of claim 14 wherein the vending machine comprises a plurality of types of dispensable articles and one of said types is dispensed via said output device based on a determined affective categorization.

16. A system for affective computing, comprising:
at least one input device connectable to a network;
at least one output device respective to at least one of said input devices;
a processor connectable to the network, wherein the processor is configured to:
receive a voice message from the at least one input device;
isolate the syllable segments of the voice message;
extract a set of paralanguage attributes of the voice message;
determine an affective categorization associated with the voice message;
send the affective categorization to one of said output devices, wherein
the output device is controlled to respond to the voice message based on the affective categorization.

17. The system of claim 16, wherein the processor, the at least one input device and the at least one output device are located within a computing device.

18. The system of claim 16 where in the processor is located within a server that is remote from a computing device that comprises said at least one input device and said at least one output device.

19. The system of claim 16 wherein the paralanguage attributes comprise one or more of pitch, pace, tone, melody, and volume.

20. The system of claim 19 wherein the paralanguage attributes comprise all five of pitch, pace, tone, melody, and volume.
